(19) United States
(12) Patent Application Publication
(10) Pub. No.: US 2013/0228531 A1
(43) Pub. Date: Sep. 5, 2013

(54) METHOD AND WATER TREATMENT IN AN INDUSTRIAL PROCESS

(71) Applicants: Matthias Fiebiger, Braunschweig (DE); Andreas Hauser, Singapore (SG); Jochen Schäfer, Nurnberg (DE)

(72) Inventors: Matthias Fiebiger, Braunschweig (DE); Andreas Hauser, Singapore (SG); Jochen Schäfer, Nurnberg (DE)

(73) Assignee: SIEMENS AKTIENGESELLSCHAFT, München (DE)

(21) Appl. No.: 13/988,273

(22) PCT Filed: Nov. 15, 2011
(86) PCT No.: PCT/EP2011/070140

§ 371 Date: May 17, 2013

(30) Foreign Application Priority Data
Nov. 19, 2010 (DE) 1020100441724

(51) Int. Cl. C02F 1/02

(52) U.S. Cl. CPC C02F 1/02
USPC 210/774

(57) ABSTRACT

Water is treated via a thermal water treatment process, where heat for the thermal water treatment process is taken off from a second thermal process by heat exchange. The treated water is fed to an evaporation process.

### CROSS REFERENCE TO RELATED APPLICATIONS

This application is the U.S. national stage of International Application No. PCT/EP2011/070140, filed Nov. 15, 2011 and claims the benefit thereof. The International Application claims the benefits of German Application No. 102010044172.4 filed on Nov. 19, 2010, both applications are incorporated by reference herein in their entirety.

### BACKGROUND

Described below is a method for water treatment in an industrial process. In order to treat feed and boiler water in industrial processes, in particular for the degasification and for the extraction of mineral solution products in feed or boiler water, this water is treated before evaporation processes. In this case, in particular, chemical methods and, with regard to demineralization, what is known as reverse osmosis or ion exchange methods are used. Such treatment methods are particularly energy-consuming and technically complicated.

### SUMMARY

An aspect is to provide a method for treating water for an industrial process which, as compared with a known method, is advantageous with respect to an energy balance.

According to the method, for the purpose of treating water, in particular for treating feed water or boiler water, in an industrial process, a thermal water treatment process is applied. In this case, for the thermal water treatment process, heat is extracted from a second thermal process by heat exchange.

An advantage is in the fact that heat from an industrial process is not discharged to the environment but is used for treating water by a heat exchange process.

Here, it is expedient that the treated water is fed in particular to an evaporation process. In this connection, evaporation process is understood to mean that the water is evaporated and a further process is energized with the steam produced. The steam can be used, for example, for the disinfection of materials; it can also be used for heating boilers or for the direct heating of material.

Under the term feed water or boiler water, the following is respectively understood: feed water is fresh water which is fed to the process from the water supply. Boiler water is water which is used for multiple application in a process and is recovered in each case.

Evaporation, volatilization or what is known as membrane distillation have proven to be expedient thermal water treatment processes. Evaporation is understood to mean processes in which water is heated above the boiling point. Volatilization is the transition of water into the gas phase at temperatures below the boiling point. Membrane distillation is a method in which water can be demineralized with the aid of thermal energy and by using a membrane.

A particularly advantageous refinement provides a heat exchange medium to transport heat between the second process and the water treatment process. In this case, the process temperature of the second process upon reaching the water treatment process lies between 60° C. and 110° C., in particular between 70° C. and 100° C.

In the temperature level between 70° C. and 100° C., the heat potential is very high. The utilization potential is in turn very low because of the technology. This resides in the fact that temperatures between 70 and 100° C. are not suitable for most thermal processes, in particular for driving a turbine. Precisely one such process with waste heat between 70 and 100° C. is therefore highly suitable for the water treatment, since in particular a volatilization process or a membrane distillation method for demineralization can be operated at these temperatures.

The expenditure when treating boiler and feed water, in particular for further evaporation, is considerable, particularly when the process steam is also used directly with the raw materials to be heated. This is the case, for example, in the foodstuffs industry, foodstuffs being heated by steam, or in the paper industry. This is because, here, the steam is consumed and cannot be recovered, which leads to new feed water having to be fed into the process in each case and having to be treated appropriately.

By the use of a multi-stage volatilization method, high water purities are achieved. As a result, problems such as corrosion or deposition in the downstream processes are reduced. The degasification and demineralization are carried out in one operation within the volatilization method. A plurality of specific methods in this regard is not required.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 shows a schematic illustration relating to water treatment by using the process waste heat from a further process and

FIG. 2 shows a schematic illustration of a membrane distillation plant.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

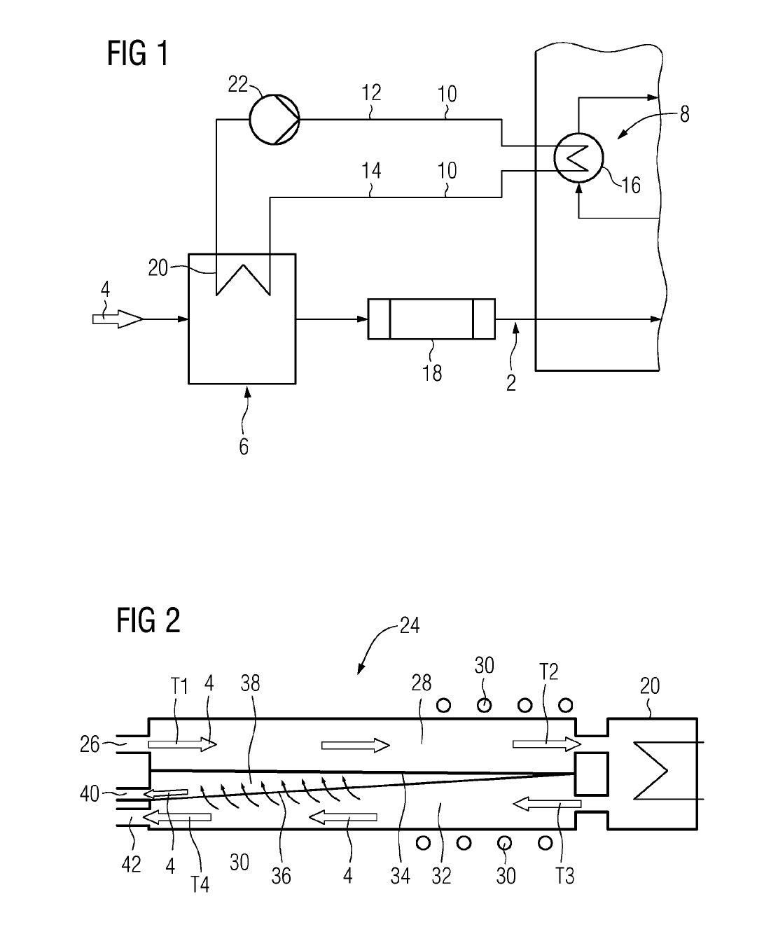

In FIG. 1, the process for water treatment is described schematically. Here, water 4, which is indicated by the arrow on the left, is led into a water treatment process 6. Here, this can be boiler water already used once or fresh water or feed water. The treatment of the water 4 in the treatment process 6 serves for subsequent evaporation in a steam generator 18. The steam generated in the steam generator 18 by an evaporation process 2 can be used in various ways in further operations. The steam can be used, for example, for controlling the temperature of foodstuffs. Furthermore, the steam can be used in the paper industry. The steam can be applied for temperature control or else for disinfection.

For the purpose of water treatment in the water treatment process 6, heat is extracted from a second thermal process 8 via a heat exchanger 16. A heat exchange medium 10 in a closed circular process has a temperature in the heat exchanger 16 between 60 and 110° C., in particular between 70 and 100° C. The heat exchange medium 10 is fed to the evaporation process 6 in the warm state 14. Here, once more a heat exchanger 20 is provided, which discharges the heat from the warm heat exchange medium 14 to the water 4. Here, the water 4 is heated. The heat exchange medium 10 is led to the process 8 as cold heat exchange medium 12 via a pump 22 and is fed back to the heat exchanger 16. The circuit begins again.

The thermal water treatment process 6 can be, for example, an evaporation method, a volatilization method or a membrane distillation method. In particular, the two last-named methods will be discussed further below.

The volatilization method is a method which is applied below 100° C. Therefore, this method, in particular as a multi-stage volatilization method, is particularly well suited for using the low-grade waste heat from the thermal process 8, which generally supplies temperatures of less than 100° but more than 70°. Processes with waste heat in these temperature ranges frequently occur in industrial applications but are difficult to utilize for heat recovery. This resides in particular in the fact that temperatures below 100° are not suitable to drive a steam turbine for power generation. As a rule, processes from this temperature range are cooled down by the heat energy simply being discharged to the environment. Described herein is an energetically very beneficial method using quantities of waste heat, which are difficult to use, economically and ecologically advantageously.

As a further advantageous refinement, a membrane distillation method can be used for the water treatment process 6. Membrane distillation is normally used for the desalination of seawater but can expediently be applied to the treatment and demineralization of feed water intrinsically containing little salt. Membrane distillation is a mixture of thermal and membrane desalination methods, in which a hydrophobic membrane 36 is used, which allows only water vapor through but holds back liquid water. On one side 36 of the membrane there is warm mineral-containing water and on the other side a colder surface. The counter-current operation of the plant achieves the situation where there is a temperature difference over the entire lengths of the membrane (cf. FIG. 2). The difference in the water vapor partial pressure that is produced thereby has the effect that water molecules pass from the warm to the cold side of the membrane 36. The membrane is hydrophobic, therefore made of a material which prevents it from being wetted directly by the liquid water 4. Polytetrafluoroethylene, for example, is suitable for this purpose. The membrane 36 is very thin and has pore sizes of about 35 μm. In industrial applications, it is fixed to a plastic substrate, not illustrated here, that is used for mechanical support. This substrate has larger pores and likewise is formed of a hydrophobic material. The system operates in accordance with the heat transfer principle. The cold, mineral-containing water flows in through a condenser inlet 26 and is warmed by the heat of condensation from, for example, 20° C. (T1) to, for example, 75° C. (T2). After that, according to FIG. 2, which represents an exemplary illustration of the water treatment process 6 according to FIG. 1, it is heated by the heat exchanger 20 to 80° C., in order to achieve an adequately high temperature difference. The water 4 is led into an evaporator channel 32 and diffuses through the membrane 36 as vapor. Immediately thereafter, the water 4 of the membrane 36 condenses against film 34, which is cooled on the counter-current principle by the cold water 4 which runs in through the condenser channel 28. In a distillate channel 38, the condensed water 4 is led away via a distillate discharge 40. The water 4 having a higher mineral concentration runs away via the concentrate discharge 42.

The water 4 that has run off through the concentrate discharge 42 can be fed to the membrane distillation a further time. The water 4 that has run off through the distillate discharge 40 can be fed onward directly to the steam generator 18.

The heat that is fed via the heat exchangers 16 and 20 to the water treatment process 6 can originate from the same industrial process into which the water vapor from the evaporation process 2 is also fed. However, it may also be expedient, within an industrial operation involving various independent processes, to recover the waste heat which lies in the range between 60° C. and 110° C. or in the range between 70° C. and 100° C. into a heat store and to feed the heat to the thermal water treatment process. In this way, the heat otherwise discharged uselessly to the environment can be fed firstly to a central energy store, not illustrated here, and then used for thermal water treatment processes, which can each also be present in a plurality in an industrial operation.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-5. (canceled)

6-10. (canceled)

6. A method for water treatment, comprising:
extracting heat from a thermal process using a heat exchange medium; and
treating water by a water treatment process using the heat transported from the thermal process by the heat exchange medium which has a temperature between 60° C. and 110° C. upon reaching the water treatment process.

7. The method as claimed in claim 6, wherein the temperature of the heat exchange medium is between 70° C. and 100° C. upon reaching the water treatment process.

8. The method as claimed in claim 7, further comprising supplying treated water produced by said treating to an evaporation process.

9. The method as claimed in claim 8, wherein the water treatment process includes at least one of an evaporation process, a volatilization process and a membrane distillation process.

10. The method as claimed in claim 9, wherein the volatilization method is a multi-stage volatilization method.

11. The method as claimed in claim 10, wherein the thermal process is part of papermaking or food processing.
